(19) United States
(12) Patent Application Publication
(10) Pub. No.: US 2026/0221458 A1
(43) Pub. Date: Jul. 30, 2026

(54) POSITIVE ELECTRODE PLATE, SECONDARY BATTERY, AND ELECTRONIC APPARATUS

(71) Applicant: Ningde Amperex Technology Limited, Ningde (CN)

(72) Inventor: Xiaoqian LIU, Ningde (CN)

(73) Assignee: Ningde Amperex Technology Limited, Ningde (CN)

(21) Appl. No.: 19/459,639

(22) Filed: Jan. 26, 2026

(30) Foreign Application Priority Data
Jan. 26, 2025 (CN) 202510123303.0

(51) Int. Cl. H01M 4/62; H01M 4/02; H01M 4/131; H01M 4/525; H01M 10/0525

(52) U.S. Cl. CPC H01M 4/625; H01M 4/131; H01M 4/525; H01M 4/623; H01M 10/0525; H01M 2004/021; H01M 2004/028

(57) ABSTRACT

A positive electrode plate includes a positive current collector and a positive electrode active material layer disposed on at least one surface of the positive current collector. The positive electrode active material layer includes a positive electrode conductive agent. The positive electrode conductive agent includes carbon black particles and first carbon nanotubes having a clustered structure. The first carbon nanotubes are composed of multiple carbon nanotube units arranged in bundles; where the particle size of the carbon black particles is R₁, with 3 nm≤R₁≤40 nm; a tube diameter of the first carbon nanotubes is 0.5 μm to 2 μm, and the diameter of individual carbon nanotube units within the first carbon nanotubes is R₂, with 5 nm≤R₂≤25 nm.

### CROSS REFERENCE TO RELATED APPLICATIONS

This application claims priority to the Chinese Patent Application Ser. No. 202510123303.0, filed on Jan. 26, 2025, the content of which is incorporated herein by reference in its entirety.

### TECHNICAL FIELD

The present application relates to the field of electrochemical technologies, and particularly to a positive electrode plate, a secondary battery, and an electronic apparatus.

### BACKGROUND

Lithium-ion secondary batteries have advantages such as high energy storage density, high open-circuit voltage, low self-discharge rate, long cycle life, and good safety, and are widely used in various fields such as electrical energy storage, mobile electronic devices, electric vehicles, and aerospace equipment. As mobile electronic devices and electric vehicles enter a stage of rapid development, the market has continuously pursued lower internal resistance in lithium-ion secondary batteries.

In the prior art, the internal resistance of a lithium-ion battery is often reduced by increasing the content of positive electrode conductive agent in the positive electrode plate or reducing the content of binder in the positive electrode plate. However, a reduction in the content of binder lowers the cohesion of the positive electrode active material layer itself or the adhesion between the positive electrode active material layer and the positive electrode current collector, thereby making the lithium-ion battery prone to thickness swelling at high temperatures (≥80° C.). Therefore, how to enable lithium-ion batteries to exhibit good high-temperature storage performance without adversely affecting the internal resistance has become a technical problem urgently to be solved by those skilled in the art.

### SUMMARY

An objective of the present application is to provide a positive electrode plate, a secondary battery, and an electronic apparatus, so that the secondary battery can exhibit good high-temperature storage performance without affecting the internal resistance.

It should be noted that in the content of the present application, lithium-ion batteries are used as an example of a secondary battery to explain the present application, but the secondary batteries in the present application are not limited to the lithium-ion batteries. The specific technical solutions are as follows.

A first aspect of the present application provides a positive electrode plate, the positive electrode plate including a positive current collector and a positive electrode active material layer disposed on at least one surface of the positive current collector. The positive electrode active material layer includes a positive electrode conductive agent. The positive electrode conductive agent includes carbon black particles and first carbon nanotubes having a clustered structure. The first carbon nanotubes are composed of multiple carbon nanotube units arranged in bundles; where the particle size of the carbon black particles is R₁, with 3 nm≤R₁≤40 nm; a tube diameter of the first carbon nanotubes is 0.5 μm to 2 μm, and the diameter of individual carbon nanotube units is R₂, with 5 nm≤R₂≤25 nm. In the positive electrode plate according to the first aspect of the present application, by adding carbon black particles and first carbon nanotubes having a clustered structure as a positive electrode conductive agent to the positive electrode active material layer, and controlling the particle size of the carbon black particles, the tube diameter of the first carbon nanotubes, and the diameter of individual carbon nanotube units within the ranges disclosed in the present application, the first carbon nanotubes with a clustered structure are distributed among the particles of the positive electrode active material to provide long-range conductive. The binder adsorbed on their surfaces is also carried into the gaps between the particles of the positive electrode active material, leading to a reduction in the content of first carbon nanotubes on the surface of the positive electrode active material layer, and a corresponding reduction in the content of binder on the surface of the positive electrode active material layer, adversely affecting the adhesion between the positive electrode active material layer and the positive current collector. Carbon black particles provide short-range conduction and have a relatively high specific surface area. After adsorbing the binder on their surfaces, carbon black particles are easily distributed on the surface of the positive electrode active material layer, which can compensate for the adhesion deficiency caused by the first carbon nanotubes. In this way, through the synergistic effect between the first carbon nanotubes and carbon black particles of the present application, relatively high adhesion is achieved between the positive electrode active material particles, and the surface of the positive electrode active material layer also exhibits relatively high adhesion, resulting in relatively high adhesion between the positive electrode active material layer and the positive current collector, and consequently, the positive electrode plate exhibits a relatively high cohesion. As a result, a secondary battery using the positive electrode plate exhibits a relatively low thickness swelling rate after high-temperature storage, that is, good high-temperature storage performance. The combination of first carbon nanotubes and carbon black particles can also improve the conductivity of the positive electrode plate, enabling a secondary battery using the positive electrode plate to have low internal resistance.

In an embodiment of the present application, R₁ and R₂ satisfy: R₁≤2R₂. When the particle size R₁ of the carbon black particles and the diameter R₂ of individual carbon nanotube units within the first carbon nanotubes satisfy the above relationship, the cohesion of the positive electrode plate can be improved, the positive electrode plate also exhibits a relatively low resistance, and the secondary battery has a relatively low thickness swelling rate during high-temperature storage.

In an embodiment of the present application, the positive electrode plate satisfies at least one of the following characteristics: (1) 8 nm≤R₁≤15 nm; (2) the tube diameter of the first carbon nanotubes is 0.8 μm to 1.2 μm; and (3) 8 nm≤R₂≤20 nm. This is beneficial for the positive electrode plate to exhibit a relatively high cohesion and a relatively low resistance, and a secondary battery using this positive electrode plate has a relatively low thickness swelling rate after high-temperature storage.

In an embodiment of the present application, based on the mass of the positive electrode active material layer, the mass percentage of the carbon black particles is W₁, and the mass percentage of the first carbon nanotubes is W₂, with 0.2%≤W₁≤1.0% and 0.2%≤W₂≤0.8%. By controlling the mass percentage of the first carbon nanotubes and carbon black particles within the above ranges, the positive electrode plate exhibits a relatively high cohesion and a relatively low resistivity, and a secondary battery using this positive electrode plate has a relatively low thickness swelling rate after high-temperature storage.

In an embodiment of the present application, W₁, W₂, R₁ and R₂ satisfy: 0.2≤(W₁/R₁)/(W₂/R₂)≤1.3. By controlling the value of (W₁/R₁)/(W₂/R₂) within the above range, it is beneficial to improve the cohesion of the positive electrode plate and reduce the resistivity of the positive electrode plate, and a secondary battery using this positive electrode plate has a relatively low thickness swelling rate after high-temperature storage.

In an embodiment of the present application, a length of the first carbon nanotubes is 5 μm to 10 μm. By controlling the length of the first carbon nanotubes within the above range, the positive electrode plate can have a relatively low resistivity while exhibiting a relatively high cohesion, so that the secondary battery has a relatively low thickness swelling rate after high-temperature storage and good processability.

In an embodiment of the present application, a specific surface area of the carbon black particles is 500 m²/g to 1600 m²/g. By controlling the specific surface area of the carbon black particles within the above range, it is beneficial for the positive electrode plate to enhance its cohesion while having a relatively low resistance. A secondary battery using the positive electrode plate has a relatively low thickness swelling rate after high-temperature storage.

In an embodiment of the present application, the specific surface area of the carbon black particles is 800 m²/g to 1400 m²/g. By controlling the specific surface area of the carbon black particles within the above range, it is beneficial to further enhance the cohesion of the positive electrode plate, thereby further reducing the thickness swelling rate of the secondary battery after high-temperature storage. The positive electrode plate also exhibits high conductive efficiency.

In an embodiment of the present application, the positive electrode conductive agent further includes individually distributed second carbon nanotubes, the tube diameter of the second carbon nanotubes is 3 nm to 20 nm, and the length of the second carbon nanotubes is 1 μm to 3 μm. When individually distributed second carbon nanotubes with tube diameters and lengths within the above ranges are further introduced into the positive electrode active material layer as a positive electrode conductive agent, the cohesion of the positive electrode plate is further enhanced, the resistance is further reduced, and the thickness swelling rate of the secondary battery after high-temperature storage is further reduced.

In an embodiment of the present application, based on the mass of the positive electrode active material layer, the mass percentage of the second carbon nanotubes is W₃, 0%<W₃≤0.5%. By controlling the mass percentage of the second carbon nanotubes within the above range, the positive electrode plate exhibits a relatively high cohesion and a relatively low resistivity, and the secondary battery has a relatively low thickness swelling rate after high-temperature storage. In an embodiment of the present application, the positive electrode active material layer further includes a binder; based on the positive electrode active material layer, the mass percentage of the positive electrode conductive agent is C₁, and the mass percentage of the binder is C₂, with 0.5≤C₁/C₂≤1.5 and 0.8%≤C₂≤3%. By controlling the mass percentage of the binder in the positive electrode active material layer and the ratio C₁/C₂ between the binder and the positive electrode conductive agent within the above ranges, the positive electrode plate exhibits a relatively high cohesion and a relatively low resistivity, and a secondary battery using this positive electrode plate exhibits a relatively low thickness swelling rate after high-temperature storage and a relatively high energy density.

In an embodiment of the present application, the binder includes at least one of polyvinylidene fluoride, vinylidene fluoride-hexafluoropropylene copolymer, polyacrylonitrile, polyacrylate, polyacrylic acid, polyacrylate salt, polyvinylpyrrolidone, polyamide, polyvinyl ether, polymethyl methacrylate, polytetrafluoroethylene, polyhexafluoropropylene, styrene-butadiene rubber, polypropylene, polyethylene, polytetrafluoroethylene, polyetherimide, hydrogenated nitrile rubber, or carboxymethyl cellulose salt. Using the above types of binders in the positive electrode active material layer is beneficial for the positive electrode plate to exhibit a relatively high cohesion, enabling a secondary battery using the positive electrode plate to have a relatively low thickness swelling rate after high-temperature storage.

In an embodiment of the present application, the positive electrode active material layer further includes a positive electrode active material. The positive electrode active material includes at least one of lithium cobaltate, lithium manganate, lithium nickelate, lithium nickel cobalt manganate, lithium nickel cobalt aluminate, lithium iron phosphate, lithium manganese iron phosphate, lithium vanadium phosphate, lithium-rich manganese-based material, or lithium titanate. Based on the mass of the positive electrode active material layer, a mass percentage of the positive electrode active material is 95.4% to 98.5%. Using the above types of positive electrode active materials and controlling the percentage of the positive electrode active material within the above ranges enable the secondary battery to have a relatively high energy density while maintaining a relatively low thickness swelling rate after high-temperature storage.

In an embodiment of the present application, a bulk density of the positive electrode active material layer is 3.9 g/cm³ to 4.15 g/cm³. By controlling the bulk density of the positive electrode active material layer within the above range, it is beneficial for the positive electrode plate to have a relatively low resistance and for the secondary battery to have a relatively low thickness swelling rate after high-temperature storage.

In an embodiment of the present application, the cohesion of the positive electrode plate is 30 N/m to 85 N/m. This indicates that the positive electrode plate exhibits a relatively high cohesion.

A second aspect of the present application provides a secondary battery, which includes the positive electrode plate according to any one of the foregoing embodiments. Therefore, the secondary battery has a relatively low thickness swelling rate after high-temperature storage, indicating that the secondary battery exhibits good storage performance.

A third aspect of the present application provides an electronic apparatus, which includes the secondary battery according to any one of the foregoing embodiments. Therefore, the electronic apparatus exhibits good operational performance.

### Beneficial Effects of the Present Application

The present application provides a positive electrode plate, a secondary battery, and an electronic apparatus. The positive electrode plate includes a positive current collector and a positive electrode active material layer disposed on at least one surface of the positive current collector. The positive electrode active material layer includes a positive electrode conductive agent. The positive electrode conductive agent includes carbon black particles and first carbon nanotubes having a clustered structure. The first carbon nanotubes are composed of multiple carbon nanotube units arranged in bundles; where the particle size of the carbon black particles is R₁, with 3 nm≤R₁≤40 nm; a tube diameter of the first carbon nanotubes is 0.5 μm to 2 μm, and the diameter of individual carbon nanotube units is R₂, with 5 nm≤R₂≤25 nm. With the above arrangement, through the synergistic effect between the first carbon nanotubes and carbon black particles of the present application, relatively high adhesion is achieved between the positive electrode active material particles, and the surface of the positive electrode active material layer also exhibits relatively high adhesion, resulting in relatively high adhesion between the positive electrode active material layer and the positive current collector, and consequently, the positive electrode plate exhibits a relatively high cohesion. As a result, a secondary battery using the positive electrode plate exhibits a relatively low thickness swelling rate after high-temperature storage. The combination of first carbon nanotubes and carbon black particles can also improve the conductivity of the positive electrode plate, enabling a secondary battery using the positive electrode plate to have low internal resistance.

Apparently, any product or method implementing the present application does not necessarily need to achieve all the above-mentioned advantages simultaneously.

### DETAILED DESCRIPTION

Hereinafter, the technical solutions in the present application will be clearly described in conjunction with embodiments of the present application. Obviously, the described embodiments are only some rather than all embodiments of the present application. All other embodiments obtained by those skilled in the art based on the present application are within the scope of protection of the present application.

It should be noted that in the specific embodiments of the present application, the lithium-ion battery is used as an example of the secondary battery to explain the present application, but the secondary battery of the present application is not limited to the lithium-ion battery.

A first aspect of the present application provides a positive electrode plate. The positive electrode plate includes a positive current collector and a positive electrode active material layer disposed on at least one surface of the positive current collector. The “positive electrode active material layer disposed on at least one surface of the positive current collector” means that the positive electrode active material layer can be disposed on one surface or two surfaces of the positive current collector along its thickness direction, and the “surface” may be a partial surface of the positive current collector or the entire surface of the positive current collector. The positive electrode active material layer includes a positive electrode conductive agent. The positive electrode conductive agent includes carbon black particles and first carbon nanotubes having a clustered structure. The first carbon nanotubes are composed of multiple carbon nanotube units arranged in bundles; where the particle size of the carbon black particles is R₁, with 3 nm≤R₁≤40 nm; a tube diameter of the first carbon nanotubes is 0.5 μm to 2 μm; and the diameter of individual carbon nanotube units is R₂, with 5 nm≤R₂≤25 nm.

For example, the tube diameter of the first carbon nanotubes is 0.5 μm, 0.7 μm, 0.8 μm, 1.0 μm, 1.1 μm, 1.2 μm, 1.3 μm, 1.5 μm, 1.7 μm, 2 μm, or any value between any two of the above numerical ranges. When the tube diameter of the first carbon nanotubes is less than 0.5 μm, the first carbon nanotubes become too thin and are prone to agglomeration. As a result, the first carbon nanotubes are unevenly distributed among the positive electrode active material particles, the content of first carbon nanotubes on the surface of the positive electrode active material layer decreases, and the content of binder adsorbed on the surface of the first carbon nanotubes also decreases on the surface of the positive electrode active material layer, leading to poor adhesion between the positive electrode active material particles in the positive electrode plate, or poor adhesion between the positive electrode active material layer and the positive current collector, reducing the cohesion of the positive electrode plate, and increasing the thickness swelling rate of the secondary battery after high-temperature storage. When the tube diameter of the first carbon nanotubes is greater than 2 μm, the first carbon nanotubes become too thick, and under the same content of first carbon nanotubes, the number of first carbon nanotubes will be too small, which reduces the number of bridges between the positive electrode active material particles. As a result, some positive electrode active material particles are left without bridging, thereby impairing the conductive efficiency and deteriorating the impedance of the secondary battery. “High temperature” in the present application refers to a temperature greater than or equal to 80° C.

For example, the diameter R₂ of individual carbon nanotube units within the first carbon nanotubes is 5 nm, 7 nm, 8 nm, 10 nm, 12 nm, 13 nm, 16 nm, 17 nm, 18 nm, 20 nm, 21 nm, 22 nm, 25 nm, or any value between any two of the above numerical ranges. When the diameter R₂ of individual carbon nanotube units within the first carbon nanotubes is less than 5 nm, the diameter of individual carbon nanotube units is too small, which is likely to make the tube diameter of the first carbon nanotubes too small, leading to agglomeration of the first carbon nanotubes. As a result, the first carbon nanotubes are unevenly distributed among the positive electrode active material particles, the content of first carbon nanotubes on the surface of the positive electrode active material layer decreases, and the content of binder adsorbed on the surface of the first carbon nanotubes also decreases on the surface of the positive electrode active material layer, leading to poor adhesion between the positive electrode active material particles in the positive electrode plate, or poor adhesion between the positive electrode active material layer and the positive current collector, reducing the cohesion of the positive electrode plate, and increasing the thickness swelling rate of the secondary battery after high-temperature storage. When the diameter R₂ of individual carbon nanotube units within the first carbon nanotubes is greater than 25 nm, the diameter of individual carbon nanotube units is too large, which affects the conductive efficiency and increases the resistance of the secondary battery.

For example, the particle size R₁ of the carbon black particles is 3 nm, 5 nm, 8 nm, 10 nm, 13 nm, 15 nm, 20 nm, 23 nm, 26 nm, 30 nm, 32 nm, 36 nm, 40 nm, or any value between any two of the above numerical ranges. Carbon black particles, after adsorbing the binder on their surfaces, are easily distributed on the surface of the positive electrode active material layer to improve the distribution of the binder in the positive electrode active material layer. When the particle size R₁ of the carbon black particles is less than 3 nm, the particle size of the carbon black particles is too small, and the carbon black particles are prone to agglomeration in the positive electrode slurry. As a result, the probability of their uniform distribution in the positive electrode active material layer is small, the probability of improving the uniformity of the binder distribution in the positive electrode active material layer is small, and the adhesion between the positive electrode active material layer and the positive current collector becomes small, leading to small cohesion of the positive electrode plate and a large thickness swelling rate of the secondary battery after high-temperature storage. When the particle size R₁ of the carbon black particles is greater than 40 nm, the specific surface area of the carbon black particles is small, and the content of the binder on its surface decreases, which also reduces the adhesion between the positive electrode active material particles, reduce the adhesion of the surface of the positive electrode active material layer, thereby reducing the cohesion of the positive electrode plate and increasing the thickness swelling of the secondary battery after high-temperature storage.

In the positive electrode plate according to the first aspect of the present application, by adding carbon black particles and first carbon nanotubes having a clustered structure as a positive electrode conductive agent to the positive electrode active material layer, and controlling the particle size of the carbon black particles, the tube diameter of the first carbon nanotubes, and the diameter of individual carbon nanotube units within the first carbon nanotubes within the ranges disclosed in the present application, the first carbon nanotubes with a clustered structure are distributed among the particles of the positive electrode active material to provide long-range conductive. The binder adsorbed on their surfaces is also carried into the gaps between the particles of the positive electrode active material, leading to a reduction in the content of first carbon nanotubes on the surface of the positive electrode active material layer, and a corresponding reduction in the content of binder on the surface of the positive electrode active material layer, adversely affecting the adhesion between the positive electrode active material layer and the positive current collector. Carbon black particles provide short-range conduction and have a relatively high specific surface area. After adsorbing the binder on their surfaces, carbon black particles are easily distributed on the surface of the positive electrode active material layer, which can compensate for the adhesion deficiency caused by the first carbon nanotubes. In this way, through the synergistic effect between the first carbon nanotubes and carbon black particles of the present application, relatively high adhesion is achieved between the positive electrode active material particles, and the surface of the positive electrode active material layer also exhibits relatively high adhesion, resulting in relatively high adhesion between the positive electrode active material layer and the positive current collector, and consequently, the positive electrode plate exhibits a relatively high cohesion. As a result, a secondary battery using the positive electrode plate exhibits a reduced thickness swelling rate after high-temperature storage. The combination of first carbon nanotubes and carbon black particles can also improve the conductive efficiency of the positive electrode plate, enabling a secondary battery using the positive electrode plate to have low internal resistance.

In an embodiment of the present application, R₁ and R₂ satisfy: R₁≤2R₂. When the particle size R₁ of the carbon black particles and the diameter R₂ of individual carbon nanotube units within the first carbon nanotubes satisfy the above relationship, the particle size of the carbon black particles is relatively small, the specific surface area is large, and the carbon black particles can carry an appropriate amount of binder on the surface of the positive electrode active material to balance the first carbon nanotubes with a clustered structure carrying the binder into the gaps between the positive electrode active material particles. As a result, the cohesion of the positive electrode plate is enhanced, the positive electrode plate also exhibits a relatively low resistance, and the secondary battery has a relatively low thickness swelling rate during high-temperature storage.

In an embodiment of the present application, 8 nm≤R₁≤15 nm. For example, the particle size R₁ of the carbon black particles is 8 nm, 9 nm, 10 nm, 11 nm, 12 nm, 13 nm, 14 nm, 15 nm, or any value between any two of the above numerical ranges. By controlling the particle size of the carbon black particles within the above range, the probability of agglomeration of the carbon black particles becomes small, and the carbon black particles also have a relatively high specific surface area. After adsorbing more binder on their surface, the carbon black particles are more easily distributed on the surface of the positive electrode active material layer, which can improve the distribution uniformity of the binder in the positive electrode active material layer, so that good adhesion is achieved between the positive electrode active material layer and the positive current collector, the positive electrode plate exhibits a relatively high cohesion, and a secondary battery using the positive electrode plate has a lower thickness swelling rate after high-temperature storage. In addition, the positive electrode plate has high conductive efficiency, and a secondary battery using the positive electrode plate exhibits low internal resistance.

In an embodiment of the present application, the tube diameter of the first carbon nanotubes is 0.8 μm to 1.2 μm. For example, the tube diameter of the first carbon nanotubes is 0.8 μm, 0.9 μm, 1.0 μm, 1.1 μm, 1.2 μm, or any value between any two of the above numerical ranges. By controlling the tube diameter of the first carbon nanotubes within the above range, it is beneficial to further promote the mutual cooperation between the first carbon nanotubes and carbon black particles, so that the positive electrode plate has a relatively high cohesion and a relatively low resistivity, enabling the secondary battery to have improved thickness swelling rate after high-temperature storage without affecting its resistance.

In an embodiment of the present application, 8 nm≤R₂≤20 nm. For example, the diameter R₂ of individual carbon nanotube units within the first carbon nanotubes is 8 nm, 10 nm, 12 nm, 13 nm, 16 nm, 17 nm, 18 nm, 20 nm, or any value between any two of the above numerical ranges. By controlling the diameter R₂ of individual carbon nanotube units within the first carbon nanotubes within the above range, it is beneficial to further promote the mutual cooperation between the first carbon nanotubes and carbon black particles, so that the positive electrode plate exhibits a relatively high cohesion and a relatively low resistivity, enabling the secondary battery to have improved thickness swelling rate after high-temperature storage without affecting its resistance.

In the present application, the “particle size of carbon black particles” refers to the average value of the equivalent diameter of the primary particles of carbon black particles. The equivalent diameter usually refers to the diameter of a sphere with the same volume as an irregularly shaped object. In the present application, by obtaining a cross-section of the positive electrode plate and measuring the area of the carbon black particles on the cross-section, the diameter of a circle with the same area is used as the equivalent diameter of the carbon black particles. The method for controlling the particle size of carbon black particles is not particularly limited in the present application, as long as the objective of the present application can be achieved. For example, such control can be achieved by directly purchasing carbon black particles with particle sizes within the range of the present application, or by crushing, grinding, or ball milling.

In an embodiment of the present application, based on the mass of the positive electrode active material layer, the mass percentage of the carbon black particles is W₁, and the mass percentage of the first carbon nanotubes is W₂, with 0.2%≤W₁≤1.0% and 0.2%≤W₂≤0.8%. For example, the mass percentage W₁ of the carbon black particles is 0.2%, 0.3%, 0.4%, 0.5%, 0.6%, 0.7%, 0.8%, 0.9%, 1.0%, or any value between any two of the above numerical ranges. The mass percentage W₂ of the first carbon nanotubes is 0.2%, 0.3%, 0.4%, 0.5%, 0.6%, 0.7%, 0.8%, or any value between any two of the above numerical ranges. By controlling the mass percentage of the first carbon nanotubes and carbon black particles within the above range, the first carbon nanotubes and carbon black particles can form effective long-range and short-range conductive networks in the positive electrode active material layer, providing good conductive performance for the positive electrode plate, and also achieving good adhesion between the positive electrode active material particles and on the surface of the positive electrode active material layer while providing good conductive efficiency. In this way, the positive electrode plate exhibits a relatively high cohesion and a relatively low resistivity, and a secondary battery using this positive electrode plate has a relatively low thickness swelling rate after high-temperature storage.

In an embodiment of the present application, W₁, W₂, R₁ and R₂ satisfy: 0.2≤(W₁/R₁)/(W₂/R₂)≤1.5. For example, the value of (W₁/R₁)/(W₂/R₂) is 0.2, 0.4, 0.5, 0.7, 0.8, 1, 1.1, 1.2, 1.3, 1.4, 1.5, or any value between any two of the above numerical ranges, preferably in the range of 0.2 to 1.3. By controlling the value of (W₁/R₁)/(W₂/R₂) within the above range, the carbon black particles and the first carbon nanotubes are matched, which is beneficial to enhance the cohesion of the positive electrode plate and reduce the resistivity of the positive electrode plate, and a secondary battery using this positive electrode plate has a relatively low thickness swelling rate after high-temperature storage.

In an embodiment of the present application, a length of the first carbon nanotubes is 5 μm to 10 μm. For example, the length of the first carbon nanotubes is 5 μm, 6 μm, 7 μm, 8 μm, 9 μm, 10 μm, or any value between any two of the above numerical ranges. By controlling the length of the first carbon nanotubes within the above range, without affecting the processing of the positive electrode active material layer slurry, it is beneficial for the first carbon nanotubes to bridge and form a long-range conductive network, thereby enabling the positive electrode plate to enhance its cohesion while having a relatively low resistivity, so that the secondary battery has a relatively low thickness swelling rate after high-temperature storage and good processability.

In an embodiment of the present application, a specific surface area of the carbon black particles is 500 m²/g to 1600 m²/g. For example, the specific surface area of the carbon black particles is 500 m²/g, 600 m²/g, 620 m²/g, 700 m²/g, 768 m²/g, 800 m²/g, 900 m²/g, 1000 m²/g, 1100 m²/g, 1200 m²/g, 1300 m²/g, 1400 m²/g, 1500 m²/g, 1600 m²/g, or any value between any two of the above numerical ranges. By controlling the specific surface area of the carbon black particles within the above range, the carbon black particles have a relatively high specific surface area and are more likely to adsorb the binder on their surfaces. After adsorbing the binder, the carbon black particles are easily and uniformly distributed on the surface of the positive electrode active material layer, so that the positive electrode active material layer and the positive current collector have good adhesion, which is beneficial for the positive electrode plate to exhibit a relatively high cohesion while having low resistance. A secondary battery using the positive electrode plate has a relatively low thickness swelling rate after high-temperature storage.

In an embodiment of the present application, the specific surface area of the carbon black particles is 800 m²/g to 1400 m²/g. For example, the specific surface area of the carbon black particles is 800 m²/g, 900 m²/g, 1000 m²/g, 1100 m²/g, 1200 m²/g, 1300 m²/g, 1400 m²/g, or any value between any two of the above numerical ranges. By controlling the specific surface area of the carbon black particles within the above range, it is beneficial to further improve the cohesion of the positive electrode plate, thereby further reducing the thickness swelling rate of the secondary battery after high-temperature storage. The positive electrode plate also has high conductive efficiency.

The method for controlling the particle size and specific surface area of carbon black particles is not particularly limited in the present application, as long as the objective of the present application can be achieved. For example, such control can be achieved by mechanical crushing (for example, ball milling). Generally, when other preparation conditions remain unchanged, extending the ball milling time reduces the particle size of carbon black particles and increases their specific surface area; while shortening the ball milling time increases the particle size of carbon black particles and decreases their specific surface area.

In an embodiment of the present application, the positive electrode conductive agent further includes individually distributed second carbon nanotubes, the tube diameter of the second carbon nanotubes is 3 nm to 20 nm, and a length of the second carbon nanotubes is 1 μm to 3 μm. For example, the tube diameter of the second carbon nanotubes is 3 nm, 5 nm, 7 nm, 9 nm, 10 nm, 12 nm, 14 nm, 16 nm, 18 nm, 19 nm, 20 nm, or any value between any two of the above numerical ranges. For example, the length of the second carbon nanotubes is 1 μm, 1.2 μm, 1.5 μm, 1.7 μm, 1.8 μm, 2 μm, 2.2 μm, 2.5 μm, 2.7 μm, 2.8 μm, 3 μm, or any value between any two of the above numerical ranges. When individually distributed second carbon nanotubes with tube diameters and lengths within the above ranges are further introduced into the positive electrode active material layer as a positive electrode conductive agent, the second carbon nanotubes provide medium-range conduction and can synergistically interact with the first carbon nanotubes and carbon black particles to establish short-range, medium-range, and long-range conductive networks in the positive electrode active material layer, so that the positive electrode plate exhibits better conductivity, and the positive electrode plate has better adhesion between the positive electrode active material particles and on the surface of the positive electrode active material layer. In this way, the cohesion of the positive electrode plate is further improved, the resistance is further reduced, and the thickness swelling rate of the secondary battery after high-temperature storage is further reduced.

In an embodiment of the present application, based on the mass of the positive electrode active material layer, the mass percentage of the second carbon nanotubes is W₃, with 0%<W₃≤0.5%. For example, the mass percentage of the second carbon nanotubes is 0.01%, 0.1%, 0.2%, 0.3%, 0.4%, 0.5%, or any value between any two of the above numerical ranges. By controlling the mass percentage of the second carbon nanotubes within the above range, it is beneficial to form an effective medium-range conductive network in the positive electrode active material layer, so as to cooperate with the first carbon nanotubes and carbon black particles to provide good conductive performance for the positive electrode active material layer. The positive electrode plate exhibits better adhesion between the positive electrode active material particles and on the surface of the positive electrode active material layer. As a result, the positive electrode plate exhibits a relatively high cohesion and a relatively low resistivity, and the secondary battery has a relatively low thickness swelling rate after high-temperature storage.

In an embodiment of the present application, the positive electrode active material layer further includes a binder; based on the mass of the positive electrode active material layer, the mass percentage of the positive electrode conductive agent is C₁, and the mass percentage of the binder is C₂, with 0.5≤C₁/C₂≤1.5 and 0.8%≤C₂≤3%. For example, the value of C₁/C₂ is 0.5, 0.6, 0.7, 0.8, 0.9, 1, 1.1, 1.2, 1.3, 1.4, 1.5, or any value between any two of the above numerical ranges. For example, the mass percentage C₂ of the binder is 0.8%, 0.9%, 1.0%, 1.2%, 1.5%, 1.7%, 1.9%, 2.0%, 2.1%, 2.3%, 2.5%, 2.6%, 2.8%, 3%, or any value between any two of the above numerical ranges. By controlling the mass percentage of the binder in the positive electrode active material layer and the value of the ratio C₁/C₂ between the binder and the positive electrode conductive agent within the above range, it is beneficial to match the content of the positive electrode conductive agent and the binder, so that the positive electrode plate provides good conductivity, good adhesion between the positive electrode active material particles and between the positive electrode active material layer and the positive current collector is achieved, and the positive electrode active material layer is allowed to add as much positive electrode active material as possible, providing more capacity for the positive electrode plate. As a result, the positive electrode plate exhibits a relatively high cohesion and a relatively low resistivity, and a secondary battery using this positive electrode plate exhibits a relatively low thickness swelling rate after high-temperature storage and a relatively high energy density.

The mass percentage C₁ of the positive electrode conductive agent is not particularly limited in the present application, as long as the objective of the present application can be achieved. For example, the mass percentage C₁ of the positive electrode conductive agent is 0.4% to 2%.

In an embodiment of the present application, the binder includes at least one of polyvinylidene fluoride, vinylidene fluoride-hexafluoropropylene copolymer, polyacrylonitrile, polyacrylate, polyacrylic acid, polyacrylate salt, polyvinylpyrrolidone, polyamide, polyvinyl ether, polymethyl methacrylate, polytetrafluoroethylene, polyhexafluoropropylene, styrene-butadiene rubber, polypropylene, polyethylene, polytetrafluoroethylene, polyetherimide, hydrogenated nitrile rubber, or carboxymethyl cellulose salt. The above types of binders have good adhesion performance. Using the above types of binders in the positive electrode active material layer is beneficial for the positive electrode plate to exhibit a relatively high cohesion, and for a secondary battery using the positive electrode plate to have a relatively low thickness swelling rate after high-temperature storage.

In an embodiment of the present application, the positive electrode active material layer further includes a positive electrode active material. The positive electrode active material includes at least one of lithium cobaltate, lithium manganate, lithium nickelate, lithium nickel cobalt manganate, lithium nickel cobalt aluminate, lithium iron phosphate, lithium manganese iron phosphate, lithium vanadium phosphate, lithium-rich manganese-based material, or lithium titanate. Based on the mass of the positive electrode active material layer, a mass percentage of the positive electrode active material is 95.4% to 98.5%. For example, the mass percentage of the positive electrode active material is 95.4%, 95.7%, 96.0%, 96.3%, 96.5%, 97.0%, 97.5%, 98.0%, 98.1%, 98.5%, or any value between any two of the above numerical ranges. Using the above types of positive electrode active materials and controlling the content of the positive electrode active material within the above range are beneficial for the positive electrode active material layer to provide a larger capacity, so that the secondary battery exhibits a relatively high energy density while maintaining a relatively low thickness swelling rate after high-temperature storage.

In an embodiment of the present application, a bulk density of the positive electrode active material layer is 3.9 g/cm³ to 4.15 g/cm³. For example, the bulk density of the positive electrode active material layer is 3.9 g/cm³, 3.95 g/cm³, 3.97 g/cm³, 4.02 g/cm³, 4.05 g/cm³, 4.07 g/cm³, 4.09 g/cm³, 4.11 g/cm³, 4.13 g/cm³, 4.15 g/cm³, or any value between any two of the above numerical ranges. By controlling the bulk density of the positive electrode active material layer within the above range, it is beneficial for the positive electrode plate to have a relatively low resistance and for the secondary battery to have a relatively low thickness swelling rate after high-temperature storage.

The method for controlling the bulk density of the positive electrode active material layer is not particularly limited in the present application, as long as the objective of the present application can be achieved. For example, such control can be achieved by controlling the particle size of the positive electrode active material, the cold pressing pressure and time, and the like during the preparation of the positive electrode plate.

In an embodiment of the present application, the cohesion of the positive electrode plate is 30 N/m to 85 N/m. For example, the cohesion of the positive electrode plate is 30 N/m, 40 N/m, 42 N/m, 50 N/m, 55 N/m, 60 N/m, 62 N/m, 65 N/m, 70 N/m, 75 N/m, 80 N/m, 85 N/m, or any value between any two of the above numerical ranges. This indicates that the positive electrode plate exhibits a relatively high cohesion. A secondary battery using the positive electrode plate has a relatively low thickness swelling rate after high-temperature storage.

The positive current collector is not particularly limited in the present application, as long as the objective of the present application can be achieved. For example, the positive current collector may include aluminum foil or aluminum alloy foil. In the present application, the thickness of the positive current collector and the positive electrode active material layer is not particularly limited, as long as the objective of the present application can be achieved. For example, the thickness of the positive current collector is 5 μm to 20 μm. The thickness of a single positive electrode active material layer is 30 μm to 120 μm.

The preparation method of carbon black particles is not particularly limited in the present application, as long as the objective of the present application can be achieved. For example, the preparation method of carbon black particles includes but is not limited to the following steps: placing raw materials into a reaction furnace to undergo pyrolysis at a high temperature of 1000° C. to 1500° C. to generate carbon black particles, followed by blowing out from the furnace tube, cooling, and collecting the carbon black particles. The type of raw materials is not particularly limited in the present application, as long as the objective of the present application can be achieved. For example, the raw materials may include but are not limited to acetylene or tar.

The preparation method of the first carbon nanotubes is not particularly limited in the present application, as long as the objective of the present application can be achieved. For example, the preparation method of the first carbon nanotubes includes but is not limited to the following steps: using a cobalt-based or iron-based catalyst, depositing the catalyst on a silicon substrate, and placing the substrate into a reaction furnace; introducing an inert protective gas into the reaction furnace and heating the reaction furnace to 700° C. to 1000° C.; introducing a reaction gas into the reaction furnace, where carbon generated by pyrolysis of the reaction gas in the reaction furnace is deposited on the catalyst to form carbon nanotube bundles with a clustered structure; and subjecting the carbon nanotube bundles to low-speed sand milling dispersion to obtain the first carbon nanotubes with lengths and tube diameters within the range of the present application. The rotation speed of the low-speed sand milling dispersion is not particularly limited in the present application, as long as the objective of the present application can be achieved. For example, the rotation speed is 900 r/min to 1300 r/min.

The preparation method of the second carbon nanotubes is not particularly limited in the present application, as long as the objective of the present application can be achieved. For example, the preparation method of the second carbon nanotubes includes but is not limited to the following steps: using a cobalt-based or iron-based catalyst, depositing the catalyst on a silicon substrate, and placing the substrate into a reaction furnace; introducing an inert protective gas into the reaction furnace and heating the reaction furnace to 600° C. to 900° C.; introducing a reaction gas into the reaction furnace, where carbon generated by pyrolysis of the reaction gas in the reaction furnace is deposited on the catalyst to form carbon nanotube bundles with a clustered structure; and subjecting the carbon nanotube bundles to high-speed sand milling dispersion to obtain individually dispersed second carbon nanotubes with lengths and tube diameters within the range of the present application. The rotation speed of the high-speed sand milling dispersion is not particularly limited in the present application, as long as the objective of the present application can be achieved. For example, the rotation speed is 1700 r/min to 2300 r/min.

The type of inert gas is not particularly limited in the present application, as long as the objective of the present application can be achieved. For example, the inert gas includes but is not limited to any one of argon or nitrogen. The type of reaction gas is not particularly limited in the present application, as long as the objective of the present application can be achieved. For example, the reaction gas includes but is not limited to acetylene. The type of cobalt-based catalyst is not particularly limited in the present application, and those skilled in the art can choose according to needs, as long as the objective of the present application can be achieved. For example, the cobalt-based catalyst includes but is not limited to cobalt-nickel alloy. The type of iron-based catalyst is not particularly limited in the present application, and those skilled in the art can choose according to needs, as long as the objective of the present application can be achieved. For example, the iron-based catalyst includes but is not limited to iron-magnesium alloy.

Generally, the tube diameter and length of the first carbon nanotubes can be controlled by the rotation speed and time during the low-speed sand milling process. Generally, as the rotation speed and time of sand milling increase, the tube diameter and length of the first carbon nanotubes decrease; as the rotation speed and time of sand milling decrease, the tube diameter and length of the first carbon nanotubes increase. The method for controlling the diameter of individual carbon nanotube units within the first carbon nanotubes is not particularly limited in the present application, as long as the objective of the present application can be achieved. For example, such control can be achieved by controlling at least one of the temperature, the type of catalyst, the size of the catalyst, or the shape of the catalyst during the synthesis process. The tube diameter of the second carbon nanotubes can be controlled by controlling at least one of the temperature, the type of catalyst, the size of the catalyst, or the shape of the catalyst during the synthesis process. The length of the second carbon nanotubes can be controlled by controlling the rotation speed and time during the high-speed sand milling process. Generally, as the rotation speed and time of sand milling increase, the length of the second carbon nanotubes decreases; as the rotation speed and time of sand milling decrease, the length of the second carbon nanotubes increases.

The preparation method of the positive electrode plate is not particularly limited in the present application, and any preparation method known in the art can be used, as long as the objective of the present application can be achieved. For example, the preparation method of the positive electrode plate includes but is not limited to the following steps: (1) mixing the positive electrode conductive agent, binder, and positive electrode active material uniformly in the contents specified in the present application, adding a solvent, and stirring uniformly to obtain a positive electrode slurry; (2) coating the positive electrode slurry on one surface of a positive current collector, followed by drying and cold pressing to form a positive electrode plate with a positive electrode active material layer on a single side. In another embodiment, the preparation method of the positive electrode plate includes the following steps: (1) mixing the positive electrode conductive agent, binder, and positive electrode active material uniformly in the content specified in the present application, adding a solvent, and stirring uniformly to obtain a positive electrode slurry; (2) coating the positive electrode slurry on one surface of a positive current collector, followed by drying to form a positive electrode active material layer; (3) repeating step (2) on the other surface of the positive current collector, followed by cold pressing and slitting to obtain a positive electrode plate with positive electrode active material layers on two sides. The solid content of the positive electrode slurry is not particularly limited in the present application, as long as the objective of the present application can be achieved. For example, the solid content of the positive electrode slurry is 50 wt % to 80 wt %. The type of solvent is not particularly limited in the present application, as long as the objective of the present application can be achieved. For example, the solvent may include but is not limited to N-methylpyrrolidone (NMP) or deionized water.

A second aspect of the present application provides a secondary battery, which includes the positive electrode plate according to any one of the foregoing embodiments. Therefore, the secondary battery has a relatively low thickness swelling rate after high-temperature storage, indicating that the secondary battery has good storage performance.

In an embodiment of the present application, the secondary battery includes a negative electrode plate. The negative electrode plate is not particularly limited in the present application, as long as the objective of the present application can be achieved. In one embodiment, the negative electrode plate includes a negative current collector and a negative active material layer, the negative active material layer being disposed on one surface or two surfaces of the negative current collector, and the “surface” may be a partial surface of the negative current collector or the entire surface of the negative current collector. The negative current collector is not particularly limited in the present application, as long as the objective of the present application can be achieved. For example, the negative current collector may include copper foil, copper alloy foil, nickel foil, stainless steel foil, titanium foil, foam nickel, or foam copper. The negative active material layer of the present application includes a negative active material. The type of negative active material is not particularly limited in the present application, as long as the objective of the present application can be achieved. For example, the negative active material may include at least one of natural graphite, artificial graphite, mesocarbon microbeads (MCMB), hard carbon, soft carbon, silicon, silicon-carbon composite, SiOₓ (0<x<2), Li—Sn alloy, Li—Sn—O alloy, Sn, SnO, SnO₂, spinel-structured lithium titanate Li₄Ti₅O₁₂, Li—Al alloy, or metallic lithium. In the present application, the thickness of the negative current collector and the negative active material layer is not particularly limited, as long as the objective of the present application can be achieved. For example, the thickness of the negative current collector is 6 μm to 10 μm, and the thickness of the negative active material layer is 30 μm to 130 μm. Optionally, the negative active material layer may further include at least one of a negative conductive agent, a dispersant, or a negative binder. The types of negative conductive agent, dispersant, and negative binder in the negative active material layer in the present application are not particularly limited, as long as the objective of the present application can be achieved. The mass ratio of the negative active material, negative conductive agent, dispersant, and negative binder in the negative active material layer is not particularly limited in the present application, as long as the objective of the present application can be achieved. For example, the mass ratio of the negative active material, negative conductive agent, dispersant, and negative binder in the negative active material layer is (96 to 98):(0.5 to 2):(0 to 1.5):(1.0 to 1.9).

In an embodiment of the present application, the secondary battery includes a separator. The separator is disposed between the positive electrode plate and the negative electrode plate and configured to separate the positive electrode plate from the negative electrode plate, prevent internal short circuits in the secondary battery, allow electrolyte ions to pass freely, and not affect the electrochemical charging and discharging process. The separator is not particularly limited in the present application, as long as the objective of the present application can be achieved. For example, the material of the separator may include at least one of polyolefin (PO) based on polyethylene (PE) or polypropylene (PP), polyester (for example, polyethylene terephthalate (PET) film), cellulose, polyimide (PI), polyamide (PA), spandex, or aramid. The type of separator may include at least one of woven film, non-woven film, microporous film, composite film, rolled film, or spinning film. The thickness of the separator is not particularly limited in the present application, as long as the objective of the present application can be achieved.

In an embodiment of the present application, the secondary battery includes an electrolyte. The type of electrolyte is not particularly limited in the present application, and those skilled in the art can select any electrolyte known in the art according to actual needs, as long as the objective of the present application can be achieved.

In an embodiment of the present application, the secondary battery includes a packaging bag, the packaging bag being configured to accommodate the positive electrode plate, the negative electrode plate, the separator, and the electrolyte. The type of packaging bag is not particularly limited in the present application, and those skilled in the art can use any packaging bag known in the art according to actual needs, as long as the objective of the present application can be achieved.

The secondary battery of the present application is not particularly limited and may include any apparatus in which electrochemical reactions take place. For example, the secondary battery can include but is not limited to a lithium metal secondary battery, a lithium-ion secondary battery (lithium-ion battery), a lithium polymer secondary battery, and a lithium-ion polymer secondary battery.

The preparation method of the secondary battery is not particularly limited in the present application, and any preparation method well known in the art can be used, as long as the objective of the present application can be achieved. For example, the preparation method of the secondary battery includes but is not limited to the following steps: stacking a separator, a positive electrode plate, a separator, and a negative electrode plate in sequence, performing operations such as winding and folding on the stack as needed to obtain an electrode assembly with a wound structure, placing the electrode assembly into a packaging bag, injecting an electrolyte into the packaging bag and sealing the packaging bag to obtain a secondary battery; or stacking a separator, a positive electrode plate, a separator, and a negative electrode plate in sequence, fixing four corners of an entire stacked structure to obtain an electrode assembly with a stacked structure, placing the electrode assembly into a packaging bag, injecting an electrolyte into the packaging bag and sealing the packaging bag to obtain a secondary battery.

A third aspect of the present application provides an electronic apparatus, which includes the secondary battery according to any one of the foregoing embodiments. Therefore, the electronic apparatus has good usage performance.

The electronic apparatus of the present application is not particularly limited and may be any electronic apparatus known in the prior art. For example, the electronic apparatus can include but is not limited to a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notepad, a calculator, a storage card, a portable recorder, a radio, a standby power source, a motor, an automobile, a motorcycle, a power-assisted bicycle, a bicycle, a lighting appliance, a toy, a game console, a clock, an electric tool, a flash lamp, a camera, a large household battery, and a lithium-ion capacitor.

### EXAMPLES

In the following, examples and comparative examples are given to describe some embodiments of this application in more detail. Various tests and evaluations are carried out according to the following methods.

### Test Methods and Devices

### Test of Particle Size R₁ of Carbon Black Particles

(a) The lithium-ion battery was discharged at a constant current of 0.2 C to 3.0 V to reach a fully discharged state, then disassembled to obtain a positive electrode plate;
(b) the positive electrode plate was soaked in dimethyl carbonate (DMC) at room temperature for 60 minutes, removed, and air dried at room temperature;
(c) the positive electrode plate was taken and fractured in liquid nitrogen to obtain a cross-section of the positive electrode active material layer on the positive electrode plate; and
(d) the cross-section obtained in (c) was observed under a scanning electron microscope (SEM), the diameters of carbon black particles were measured at 10 different locations, and an average value thereof was taken as the particle size, where a total number of carbon black particle samples was 50.

### Test of Tube Diameter and Length of First Carbon Nanotubes

(a) The lithium-ion battery was discharged at a constant current of 0.2 C to 3.0 V to reach a fully discharged state, then disassembled to obtain a positive electrode plate;
(b) the positive electrode plate was soaked in DMC at room temperature for 60 minutes, removed, and air dried at room temperature;
(c) the positive electrode plate was taken and fractured in liquid nitrogen to obtain a cross-section of the positive electrode active material layer on the positive electrode plate; and
(d) the cross-section obtained in (c) was observed under SEM, the tube diameter/length of the first carbon nanotubes were measured at 10 different locations, an average value thereof was taken as the target value, and the number of first carbon nanotubes measured was 30, where the first carbon nanotubes were carbon nanotubes with a clustered structure in the cross-section.

### Test of Diameter R₂ of Individual Carbon Nanotube Units in First Carbon Nanotubes

(a) The lithium-ion battery was discharged at a constant current of 0.2 C to 3.0 V to reach a fully discharged state, then disassembled to obtain a positive electrode plate;
(b) the positive electrode plate was soaked in DMC at room temperature for 60 minutes, removed, and air dried at room temperature;
(c) the positive electrode plate was taken and fractured in liquid nitrogen to obtain a cross-section of the positive electrode active material layer on the positive electrode plate; and
(d) the cross-section obtained in (c) was observed under SEM, the diameter of individual carbon nanotube units within the first carbon nanotubes was measured at 10 different locations, an average value thereof was taken as the target value, and the number of first carbon nanotubes measured was 30, where the first carbon nanotubes were carbon nanotubes with a clustered structure in the cross-section.

### Test of Specific Surface Area of Carbon Black Particles

A specific surface area analyzer (Tristar II 3020M, Micromeritics Instrument Corporation, USA) was used to measure the specific surface area of the carbon black particles in each example and comparative example by using the nitrogen adsorption method. The specific test was carried out according to the national standard GB/T 19587-2017 “Determination of specific surface area of solid materials by gas adsorption BET method”.

### Test of Tube Diameter and Length of Second Carbon Nanotubes

(a) The lithium-ion battery was discharged at a constant current of 0.2 C to 3.0 V to reach a fully discharged state, then disassembled to obtain a positive electrode plate;
(b) the positive electrode plate was soaked in DMC at room temperature for 60 minutes, removed, and air dried at room temperature;
c) the positive electrode plate was taken and fractured in liquid nitrogen to obtain a cross-section of the positive electrode active material layer on the electrode plate; and
(d) the cross-section obtained in (c) was observed under SEM, the tube diameter/length of the second carbon nanotubes were measured at 10 different locations, an average value thereof was taken as the target value, and the number of second carbon nanotubes measured was 30, where the second carbon nanotubes were individually distributed carbon nanotubes in the cross-section.

### Test of Bulk Density of Positive Electrode Active Material Layer

(a) The lithium-ion battery was discharged at a constant current of 0.2 C to 3.0 V to reach a fully discharged state;
(b) the lithium-ion battery was disassembled to obtain a positive electrode plate;
(c) the positive electrode plate obtained in (b) was soaked in DMC at room temperature for 30 minutes, then removed and air dried;
(d) the positive electrode plate from (c) was taken and cut by plasma cutting to obtain a cross-section of the positive electrode active material layer on the positive electrode plate, the thickness of the positive current collector was observed and measured under SEM at 10 locations, and an average value thereof was taken as h (cm); and
(e) the positive electrode plate from (c) was taken and punched using a cutter with a fixed area S (cm²) to obtain a film, a single film was weighted as W₁ (g), the thickness of the film at 5 locations was measured with a micrometer, an average value thereof was taken as H₁ (cm), then its bulk density was W₁/(H₁−h)/S; for each example and comparative example, 6 films were tested for bulk density, and an average value thereof was taken as the final value of the bulk density.

### Test of Cohesion of Positive Electrode Plate

(a) The lithium-ion battery was discharged at a constant current of 0.2 C to 3.0 V to reach a fully discharged state, then disassembled to obtain a positive electrode plate;
(b) the positive electrode plate was soaked in DMC at room temperature for 60 minutes, removed, and air dried at room temperature; and
(c) the positive electrode plate was taken, and the cohesion of the positive electrode active material layer was tested using a high-speed tensile testing machine and a 90° peel method commonly used in the lithium battery industry:
the positive electrode plate from (b) was prepared into strips with a width of 30 mm and a length of 10 cm. Along the length direction, one side of the positive electrode active material layer (referred to as side A) was placed upward, while the other side was adhered to a steel plate using double-sided adhesive tape; then, one end of a 20 mm wide adhesive tape was taken and attached to the center position of side A along the width direction, leaving an unstuck end of about 5 cm long; the steel plate was fixed in the corresponding position of the high-speed tensile testing machine, with the unstuck end of the adhesive tape clamped in the upper grip; and the high-speed tensile testing machine started the test when the tensile force at the grip was greater than 0 kgf and less than 0.02 kgf. The final average value of the tensile force in the stable region was recorded as the adhesion between the positive electrode active material layer and the positive current collector. In particular, the ratio of the standard deviation to the average value of the adhesion data in this stable region shall not exceed 10%.

### Test of Thickness Swelling Rate

After the lithium-ion battery was charged at a constant current of 0.5° C. to 4.5V to reach a fully charged state, its thickness was measured and recorded as the initial thickness.

The fully charged lithium-ion battery obtained above was placed in a high and low temperature chamber at 80° C. for storage, and the thickness of the lithium-ion battery after 7 hours of storage was recorded as the final thickness. The thickness of the lithium-ion battery was measured using a PPG thickness gauge, with a measuring pressure of 300 g.

Lithium-ion battery thickness swelling rate (%)=(final thickness−initial thickness)/initial thickness×100%.

### Test of Resistance

(1) The lithium-ion battery was discharged at a constant current of 0.2 C to 3.0V to reach a fully discharged state
(2) the lithium-ion battery was disassembled to obtain a positive electrode plate;
(3) the positive electrode plate obtained in (2) was soaked in DMC at room temperature for 30 minutes, removed, and air dried; and
(4) a BER1200 model film resistance tester was used to test the resistance of the positive electrode plate obtained in (3). The interval between adjacent test points was 2 mm to 3 mm, and 15 different points were tested. An average value of the resistance of all test points was recorded as the full-charge wet film resistance of the positive electrode plate. The test parameters included: probe area 153.94 mm², pressure 3.5 t, and holding time 50 s.

The resistance of the positive electrode plate is used to characterize the internal resistance of the lithium-ion battery. A smaller resistance indicates a smaller internal resistance of the lithium-ion battery.

### Example 1-1

### <Preparation of Positive Electrode Plate>

Preparation of carbon black particles: Acetylene was used as the raw material, and the raw material was place into a reaction furnace at 1500° C. for pyrolysis to produce carbon black particles. The carbon black particles were blown out from the furnace tube, cooled, and collected. After crushing and sieving, carbon black particles with particle size R₁ as shown in Table 1 were obtained.

Preparation of first carbon nanotubes: An iron-magnesium alloy catalyst was used, the catalyst was deposited on a silicon substrate, and the substrate was placed into a reaction furnace; argon was introduced into the reaction furnace, and the temperature of the reaction furnace was adjusted to 800° C.; acetylene was introduced into the reaction furnace, and the carbon generated by pyrolysis of acetylene in the reaction furnace was deposited and grown on the catalyst to form carbon nanotubes; and first carbon nanotubes with a clustered structure were obtained by subjecting the carbon nanotubes to low-speed (1100 r/min rotation speed) sand milling dispersion.

The positive electrode active material lithium cobaltate, a positive electrode conductive agent, and binder polyvinylidene fluoride (PVDF, weight average molecular weight of 80 W) were mixed, and added with N-methylpyrrolidone (NMP) as a solvent. The resulting mixture was stirred in a vacuum mixer until a uniform positive electrode slurry with a solid content of 75 wt % was obtained. The positive electrode slurry was uniformly coated on one surface of a 6 μm thick aluminum foil positive current collector, and dried at 90° C. to obtain a positive electrode plate with a positive electrode active material layer on a single side. Subsequently, the above steps were repeated on the other surface of the aluminum foil to obtain a positive electrode plate with positive electrode active material layers on two sides. After cold pressing and slitting, a positive electrode plate with specifications of 74 mm×851 mm was obtained for use. The coating weight of the positive electrode active material layer was 280 mg/1540.25 mm².

Here, the positive electrode conductive agent included the carbon black particles and the first carbon nanotubes prepared above. Based on the mass of the positive electrode active material layer, the mass percentage of the positive electrode active material was 97.8%, the mass percentage W₁ of the carbon black particles was 0.3%, the mass percentage W₂ of the first carbon nanotubes was 0.5%, and the mass percentage C₂ of the binder was 1.4%.

### <Preparation of Negative Electrode Plate>

The negative active material artificial graphite, negative conductive agent acetylene black, negative binder styrene-butadiene rubber (SBR, weight average molecular weight of 5×10⁶), and dispersant carboxymethyl cellulose (CMC) were mixed in a mass ratio of 96:2:1:1, then added with deionized water as a solvent, and stirred in a vacuum mixer until a uniform negative electrode slurry with a solid content of 50 wt % was obtained. The negative electrode slurry was uniformly coated on one surface of an 8 μm thick copper foil negative current collector, and dried at 90° C. to obtain a negative electrode plate with a negative active material layer (thickness 130 μm) on a single side. Subsequently, the above steps were repeated on the other surface of the copper foil to obtain a negative electrode plate with negative active material layers on two sides. After cold pressing and slitting, a negative electrode plate with specifications of 76 mm×856 mm was obtained for use.

### <Preparation of Separator>

A polyethylene (PE) porous film with a thickness of 8 μm was used as the separator.

### <Preparation of Electrolyte>

In a dry argon atmosphere, organic solvents ethylene carbonate, ethyl methyl carbonate, and diethyl carbonate were mixed in a mass ratio of 30:50:20 to obtain a base electrolyte. Then, lithium salt lithium hexafluorophosphate was added to the base electrolyte, dissolved, and uniformly mixed to obtain an electrolyte with a lithium salt concentration of 1.15 mol/L.

### <Preparation of Lithium-Ion Battery>

The separator, positive electrode plate, separator, and negative electrode plate were stacked in sequence, and wound to obtain an electrode assembly. The electrode assembly was placed in an aluminum-plastic film packaging bag and dried, then an electrolyte was injected, followed by vacuum packaging, standing, formation, degassing, trimming, and other processes, to obtain a lithium-ion battery.

### Examples 1-2 to 1-33

The same as Example 1-1 except that the related preparation parameters were adjusted according to Table 1.

When the mass percentage of carbon black particles and/or first carbon nanotubes in the positive electrode active material layer changes, the mass percentage of the positive electrode active material changes accordingly, while the mass percentage of the binder remains unchanged. The total mass percentages of carbon black particles, first carbon nanotubes, positive electrode active material, and binder is 100%.

### Examples 2-1 to 2-4

The same as Example 1-1 except that the related preparation parameters were adjusted according to Table 2.

### Examples 3-1 to 3-6

The same as Example 1-1 except that the related preparation parameters were adjusted according to Table 3.

When the mass percentage of carbon black particles and/or first carbon nanotubes in the positive electrode active material layer changes, the mass percentage of the positive electrode active material changes accordingly, while the mass percentage of the binder remains unchanged. The total mass percentage of carbon black particles, first carbon nanotubes, positive electrode active material, and binder is 100%.

### Example 3-7

### <Preparation of Positive Electrode Plate>

The carbon black particles and first carbon nanotubes prepared in Example 1-1 were used.

Preparation of second carbon nanotubes: An iron-magnesium alloy catalyst was used, the catalyst was deposited on a silicon substrate, and the substrate was placed into a reaction furnace; argon gas was introduced into the reaction furnace, and the temperature of the reaction furnace was adjusted to 700° C.; acetylene was introduced into the reaction furnace, and the carbon generated by pyrolysis of acetylene in the reaction furnace was deposited and grown on the catalyst to form carbon nanotubes; and individually distributed second carbon nanotubes were obtained by subjecting the carbon nanotubes to high-speed (2000 r/min rotation speed) sand milling dispersion.

The positive electrode active material lithium cobaltate, a positive electrode conductive agent, and binder polyvinylidene fluoride (PVDF, weight average molecular weight of 80 W) were mixed, and added with N-methylpyrrolidone (NMP) as a solvent. The resulting mixture was stirred in a vacuum mixer until a uniform positive electrode slurry with a solid content of 75 wt % was obtained. The positive electrode slurry was uniformly coated on one surface of a 6 μm thick aluminum foil positive current collector, and dried at 90° C. to obtain a positive electrode plate with a positive electrode active material layer on a single side. Subsequently, the above steps were repeated on the other surface of the aluminum foil to obtain a positive electrode plate with positive electrode active material layers on two sides. After cold pressing and slitting, a positive electrode plate with specifications of 74 mm×851 mm was obtained for use. The coating weight of the positive electrode active material layer was 280 mg/1540.25 mm².

Here, the positive electrode conductive agent included the carbon black particles, first carbon nanotubes, and second carbon nanotubes prepared above. The mass percentage of the positive electrode active material, carbon black particles, first carbon nanotubes, second carbon nanotubes, and binder are shown in Table 3.

### Examples 3-8 to 3-12

The same as Example 3-7 except that the related preparation parameters were adjusted according to Table 3.

### Example 3-13

The same as Example 3-7 except that the related preparation parameters were adjusted according to Table 3, where the particle size R₁ of carbon black particles was adjusted to 40 nm, the specific surface area was adjusted to 500 m²/g, the tube diameter of the second carbon nanotubes was adjusted to 20 nm, and the length was adjusted to 1 μm.

### Example 3-14

The same as Example 3-7 except that the related preparation parameters were adjusted according to Table 3.

### Examples 4-1 to 4-7

The same as Example 1-1 except that the related preparation parameters were adjusted according to Table 4.

### Examples 5-1 to 5-9

The same as Example 3-7 except that the related preparation parameters were adjusted according to Table 5.

### Comparative Examples 1 to 13

The same as Example 1-1 except that the related preparation parameters were adjusted according to Table 1.

The preparation parameters and performance data of each example and comparative example are shown in Table 1 to Table 5.

TABLE 1

| | | Tube | | | | | | Specific | | | |
|---|---|---|---|---|---|---|---|---|---|---|---|
| | | diameter | | | | | | surface area | | | |
| | | of first | | Whether | | | | of carbon | | | |
| | | carbon | | R₁ ≤ 2R₂ | | | | black | | Thickness | Resis- |
| | R₁ | nanotubes | R₂ | is | W₁ | W₂ | (W₁/R₁)/ | particles | Cohesion | swelling | tance |
| | (nm) | (μm) | (nm) | satisfied | (%) | (%) | (W₂/R₂) | (m²/g) | (N/m) | rate | (mΩ) |
| Example 1-1 | 12 | 1 | 9.0 | Yes | 0.3 | 0.5 | 0.5 | 1300 | 60 | 10% | 380 |
| Example 1-2 | 3 | 1 | 9.0 | Yes | 0.3 | 0.5 | 1.8 | 2000 | 35 | 16% | 420 |
| Example 1-3 | 5 | 1 | 9.0 | Yes | 0.3 | 0.5 | 1.1 | 1800 | 40 | 15% | 410 |
| Example 1-4 | 8 | 1 | 9.0 | Yes | 0.3 | 0.5 | 0.7 | 1600 | 45 | 14% | 390 |
| Example 1-5 | 11 | 1 | 9.0 | Yes | 0.3 | 0.5 | 0.5 | 1400 | 50 | 13% | 370 |
| Example 1-6 | 15 | 1 | 9.0 | Yes | 0.3 | 0.5 | 0.4 | 1100 | 65 | 8% | 380 |
| Example 1-7 | 15 | 1 | 6.0 | No | 0.3 | 0.5 | 0.2 | 1100 | 40 | 15% | 350 |
| Example 1-8 | 20 | 1 | 9.0 | No | 0.3 | 0.5 | 1.3 | 900 | 45 | 14% | 410 |
| Example 1-9 | 25 | 1 | 9.0 | No | 0.3 | 0.5 | 0.2 | 800 | 40 | 15% | 450 |
| Example 1-10 | 40 | 1 | 9.0 | No | 0.3 | 0.5 | 0.1 | 500 | 30 | 18% | 500 |
| Example 1-11 | 12 | 0.5 | 9.0 | Yes | 0.3 | 0.5 | 0.5 | 1300 | 45 | 15% | 390 |
| Example 1-12 | 12 | 0.7 | 9.0 | Yes | 0.3 | 0.5 | 0.5 | 1300 | 52 | 13% | 340 |
| Example 1-13 | 12 | 0.8 | 9.0 | Yes | 0.3 | 0.5 | 0.5 | 1300 | 55 | 11% | 330 |
| Example 1-14 | 12 | 1.2 | 9.0 | Yes | 0.3 | 0.5 | 0.5 | 1300 | 65 | 8% | 380 |
| Example 1-15 | 12 | 1.5 | 9.0 | Yes | 0.3 | 0.5 | 0.5 | 1300 | 68 | 7% | 400 |
| Example 1-16 | 12 | 2 | 9.0 | Yes | 0.3 | 0.5 | 0.5 | 1300 | 70 | 6% | 430 |
| Example 1-17 | 12 | 1 | 5.0 | No | 0.3 | 0.5 | 0.3 | 1300 | 35 | 17% | 410 |
| Example 1-18 | 12 | 1 | 6.0 | Yes | 0.3 | 0.5 | 0.3 | 1300 | 37 | 16% | 400 |
| Example 1-19 | 12 | 1 | 8.0 | Yes | 0.3 | 0.5 | 0.4 | 1300 | 57 | 11% | 360 |
| Example 1-20 | 12 | 1 | 14.0 | Yes | 0.3 | 0.5 | 0.7 | 1300 | 65 | 8% | 380 |
| Example 1-21 | 12 | 1 | 20.0 | Yes | 0.3 | 0.5 | 1.0 | 1300 | 68 | 6% | 395 |
| Example 1-22 | 12 | 1 | 22.0 | Yes | 0.3 | 0.5 | 1.1 | 1300 | 70 | 5% | 420 |
| Example 1-23 | 12 | 1 | 25.0 | Yes | 0.3 | 0.5 | 1.3 | 1300 | 72 | 5% | 440 |
| Example 1-24 | 12 | 1 | 9.0 | Yes | 0.1 | 0.8 | 0.09 | 1300 | 30 | 18% | 650 |
| Example 1-25 | 12 | 1 | 9.0 | Yes | 0.2 | 0.5 | 0.3 | 1300 | 56 | 12% | 400 |
| Example 1-26 | 12 | 1 | 9.0 | Yes | 0.5 | 0.5 | 0.8 | 1300 | 55 | 12% | 280 |
| Example 1-27 | 12 | 1 | 9.0 | Yes | 1 | 0.5 | 1.5 | 1300 | 40 | 15% | 250 |
| Example 1-28 | 12 | 1 | 9.0 | Yes | 1.2 | 0.5 | 1.8 | 1300 | 30 | 18% | 250 |
| Example 1-29 | 12 | 1 | 9.0 | Yes | 0.6 | 0.2 | 2.3 | 1300 | 30 | 17% | 420 |
| Example 1-30 | 12 | 1 | 9.0 | Yes | 0.4 | 0.5 | 0.6 | 1300 | 40 | 15% | 380 |
| Example 1-31 | 12 | 1 | 9.0 | Yes | 0.3 | 0.8 | 0.3 | 1300 | 35 | 16% | 300 |
| Example 1-32 | 12 | 1 | 9.0 | Yes | 0.7 | 0.1 | 5.3 | 1300 | 30 | 18% | 460 |
| Example 1-33 | 12 | 1 | 9.0 | Yes | 0.1 | 1 | 0.08 | 1300 | 30 | 18% | 480 |
| Comparative | 1 | 1 | 9.0 | Yes | 0.3 | 0.5 | 5.4 | 2500 | 20 | 22% | 300 |
| Example 1 | | | | | | | | | | | |
| Comparative | 50 | 1 | 9.0 | No | 0.3 | 0.5 | 0.1 | 55 | 25 | 20% | 760 |
| Example 2 | | | | | | | | | | | |
| Comparative | 12 | 0.2 | 9.0 | Yes | 0.3 | 0.5 | 0.5 | 1300 | 25 | 20% | 360 |
| Example 3 | | | | | | | | | | | |
| Comparative | 12 | 2.5 | 9.0 | Yes | 0.3 | 0.5 | 0.5 | 1300 | 20 | 22% | 450 |
| Example 4 | | | | | | | | | | | |
| Comparative | 12 | 1 | 2.0 | No | 0.3 | 0.5 | 0.1 | 1300 | 20 | 22% | 400 |
| Example 5 | | | | | | | | | | | |
| Comparative | 12 | 1 | 27.0 | Yes | 0.3 | 0.5 | 1.4 | 1300 | 65 | 15% | 800 |
| Example 6 | | | | | | | | | | | |
| Comparative | 12 | 0.2 | 2.0 | No | 0.3 | 0.5 | 0.1 | 1300 | 15 | 25% | 400 |
| Example 7 | | | | | | | | | | | |
| Comparative | 12 | 2.5 | 2.0 | Yes | 0.3 | 0.5 | 0.1 | 1300 | 18 | 24% | 800 |
| Example 8 | | | | | | | | | | | |
| Comparative | 1 | 0.2 | 14.0 | Yes | 0.3 | 0.5 | 8.4 | 2500 | 15 | 25% | 330 |
| Example 9 | | | | | | | | | | | |
| Comparative | 50 | 2.5 | 14.0 | No | 0.3 | 0.5 | 0.2 | 55 | 18 | 24% | 820 |
| Example 10 | | | | | | | | | | | |
| Comparative | 50 | 2.5 | 4.0 | No | 0.3 | 0.5 | 0.05 | 55 | 10 | 30% | 700 |
| Example 11 | | | | | | | | | | | |
| Comparative | \ | 1.5 | 9.0 | \ | \ | 0.8 | \ | \ | 5 | 45% | 900 |
| Example 12 | | | | | | | | | | | |
| Comparative | 12 | \ | \ | \ | 0.8 | \ | \ | 1300 | 7 | 43% | 870 |
| Example 13 | | | | | | | | | | | |

Note:
“\” in Table 1 indicates no corresponding parameter.

From Examples 1-1 to 1-33 and Comparative Examples 1 to 13, it can be seen that in the secondary batteries of the present application, by adding carbon black particles and first carbon nanotubes having a clustered structure as a positive electrode conductive agent to the positive electrode active material layer, and controlling the particle size of the carbon black particles, the tube diameter of the first carbon nanotubes, and the diameter of individual carbon nanotube units within the first carbon nanotubes within the ranges disclosed in the present application, the positive electrode plates exhibited a relatively high cohesion and a relatively low resistance, and the secondary batteries had a relatively low thickness swelling rate after 7 hours of storage at 80° C., indicating that the secondary batteries exhibited good high-temperature storage performance without affecting internal resistance. In contrast, in the secondary batteries of the comparative examples, at least one of the particle size R₁ of the carbon black particles, the tube diameter of the first carbon nanotubes, or the diameter of individual carbon nanotube units within the first carbon nanotubes was outside the range of the present application, the cohesion of the positive electrode plate was lower, and the secondary battery had a larger thickness swelling rate after 7 hours of storage at 80° C., or the positive electrode plate exhibited a larger resistance, indicating that the secondary batteries of the comparative examples cannot achieve both low internal resistance and high high-temperature storage performance.

The particle size of carbon black particles usually affects the internal resistance and high-temperature storage performance of secondary batteries. From Examples 1-1 to 1-10, Comparative Examples 1 and 2, and Comparative Examples 9 to 13, it can be seen that in secondary batteries using carbon black particles with particle sizes within the range of the present application, its positive electrode plates exhibited a relatively high cohesion and a relatively low resistance, and the secondary batteries had a relatively low thickness swelling rate after 7 hours of storage at 80° C., indicating that the secondary batteries exhibited good high-temperature storage performance without affecting internal resistance.

The tube diameter of the first carbon nanotubes usually affects the internal resistance and high-temperature storage performance of secondary batteries. From Example 1-1, Examples 1-11 to 1-16, Comparative Examples 3 and 4, and Comparative Examples 7 to 13, it can be seen that in secondary batteries using first carbon nanotubes with tube diameters within the range of the present application, positive electrode plates exhibited a relatively high cohesion and a relatively low resistance, and the secondary batteries had a relatively low thickness swelling rate after 7 hours of storage at 80° C., indicating that the secondary batteries exhibited good high-temperature storage performance without affecting internal resistance.

The diameter of individual carbon nanotube units within the first carbon nanotubes usually affects the internal resistance and high-temperature storage performance of secondary batteries. From Example 1-1, Examples 1-17 to 1-23, and Comparative Examples 5 to 8, it can be seen that in secondary batteries using first carbon nanotubes with single carbon nanotube unit diameters within the range of the present application, positive electrode plates exhibited a relatively high cohesion and a relatively low resistance, and the secondary batteries had a relatively low thickness swelling rate after 7 hours of storage at 80° C., indicating that the secondary batteries exhibited good high-temperature storage performance without affecting internal resistance. Although the positive electrode plate of Comparative Example 6 exhibited a relatively high cohesion and the secondary battery had a relatively low thickness swelling rate after 7 hours of storage at 80° C., its positive electrode plate exhibited excessively large resistance, indicating that the secondary battery of Comparative Example 6 cannot achieve both internal resistance and high-temperature storage performance.

The mass percentage W₁ of carbon black particles usually affects the internal resistance and high-temperature storage performance of secondary batteries. From Example 1-1, Examples 1-24 to 1-29, it can be seen that in secondary batteries using carbon black particles with mass percentage W₁ within the range of the present application, positive electrode plates exhibited a relatively high cohesion and a relatively low resistance, and the secondary batteries had a relatively low thickness swelling rate after 7 hours of storage at 80° C., indicating that the secondary batteries exhibited good high-temperature storage performance without affecting internal resistance.

The mass percentage W₂ of the first carbon nanotubes usually affects the internal resistance and high-temperature storage performance of secondary batteries. From Example 1-1, Examples 1-30 to 1-33, it can be seen that in secondary batteries using first carbon nanotubes with mass percentage W₂ within the range of the present application, positive electrode plates exhibited a relatively high cohesion and a relatively low resistance, and the secondary batteries had a relatively low thickness swelling rate after 7 hours of storage at 80° C., indicating that the secondary batteries exhibited good high-temperature storage performance without affecting internal resistance.

The value of (W₁/R₁)/(W₂/R₂) usually affects the internal resistance and high-temperature storage performance of secondary batteries. From Example 1-1, Examples 1-2 to 1-10, it can be seen that in secondary batteries using a value of (W₁/R₁)/(W₂/R₂) within the range of the present application, positive electrode plates exhibited a relatively high cohesion and a relatively low resistance, and the secondary batteries had a relatively low thickness swelling rate after 7 hours of storage at 80° C., indicating that the secondary batteries exhibited good high-temperature storage performance without affecting internal resistance.

TABLE 2

| | Length of | | Thickness | |
|---|---|---|---|---|
| | first carbon | Cohesion | swelling | Resistance |
| | nanotubes (μm) | (N/m) | rate | (mΩ) |
| Example 1-1 | 7 | 60 | 10% | 380 |
| Example 2-1 | 5 | 60 | 10% | 400 |
| Example 2-2 | 10 | 60 | 10% | 360 |
| Example 2-3 | 3 | 60 | 10% | 440 |
| Example 2-4 | 12 | 60 | 12% | 330 |

The length of the first carbon nanotubes usually affects the internal resistance of secondary batteries. From Example 1-1, Examples 2-1 to 2-4, it can be seen that in secondary batteries using first carbon nanotubes with lengths within the range of the present application, positive electrode plates exhibited a relatively high cohesion and a relatively low resistance, and the secondary batteries had a relatively low thickness swelling rate after 7 hours of storage at 80° C., indicating that the secondary batteries exhibited good high-temperature storage performance and low internal resistance. Although the secondary battery of Example 2-4, compared to Example 1-1, Examples 2-1 to 2-3, exhibited lower resistance, due to the longer length of the first carbon nanotubes, the processing of the positive electrode slurry was affected, affecting the evenness of distribution of various substances in the positive electrode slurry and increasing the difficulty of coating the positive electrode slurry onto the surface of the positive current collector, thereby reducing the processability of the secondary battery and increasing production costs.

TABLE 3

| | | | | | | | Content of | | | | |
|---|---|---|---|---|---|---|---|---|---|---|---|
| | | | | | | | positive | Type of | | | |
| | | | | | | | electrode | positive | | | |
| | | | | | | | active | electrode | | Thickness | Resis- |
| | W₁ | W₂ | W₃ | C₁ | C₂ | | material | active | Cohesion | swelling | tance |
| | (%) | (%) | (%) | (%) | (%) | C₁/C₂ | (%) | material | (N/m) | rate | (mΩ) |
| Example 1-1 | 0.3 | 0.5 | 0 | 0.8 | 1.4 | 0.6 | 97.8 | Lithium | 60 | 10% | 380 |
| | | | | | | | | cobaltate | | | |
| Example 3-1 | 0.3 | 0.5 | 0 | 0.8 | 0.8 | 1.0 | 98.4 | Lithium | 30 | 18% | 310 |
| | | | | | | | | cobaltate | | | |
| Example 3-2 | 0.8 | 0.8 | 0 | 1.6 | 2.5 | 0.6 | 95.9 | Lithium | 50 | 14% | 430 |
| | | | | | | | | cobaltate | | | |
| Example 3-3 | 0.3 | 0.5 | 0 | 0.8 | 1.1 | 0.7 | 98.1 | Lithium | 55 | 12% | 360 |
| | | | | | | | | cobaltate | | | |
| Example 3-4 | 0.3 | 0.5 | 0 | 0.8 | 3 | 0.3 | 96.2 | Lithium | 80 | 5% | 480 |
| | | | | | | | | cobaltate | | | |
| Example 3-5 | 0.1 | 0.3 | 0 | 0.4 | 0.5 | 0.8 | 99.1 | Lithium | 30 | 18% | 400 |
| | | | | | | | | cobaltate | | | |
| Example 3-6 | 0.3 | 0.5 | 0 | 0.8 | 3.5 | 0.2 | 95.7 | Lithium | 85 | 3% | 530 |
| | | | | | | | | cobaltate | | | |
| Example 3-7 | 0.25 | 0.5 | 0.1 | 0.85 | 1 | 0.9 | 98.15 | Lithium | 60 | 10% | 390 |
| | | | | | | | | cobaltate | | | |
| Example 3-8 | 0.25 | 0.5 | 0.5 | 1.25 | 1 | 1.3 | 97.75 | Lithium | 55 | 12% | 280 |
| | | | | | | | | cobaltate | | | |
| Example 3-9 | 0.25 | 0.5 | 0.7 | 1.45 | 1 | 1.5 | 97.55 | Lithium | 50 | 14% | 260 |
| | | | | | | | | cobaltate | | | |
| Example 3-10 | 0.3 | 0.8 | 0.3 | 1.4 | 3 | 0.5 | 95.6 | Lithium | 55 | 12% | 380 |
| | | | | | | | | cobaltate | | | |
| Example 3-11 | 0.2 | 0.2 | 0.3 | 0.7 | 0.8 | 0.9 | 98.5 | Lithium | 40 | 15% | 330 |
| | | | | | | | | cobaltate | | | |
| Example 3-12 | 0.3 | 0.8 | 0.5 | 1.6 | 3 | 0.5 | 95.4 | Lithium | 40 | 15% | 330 |
| | | | | | | | | cobaltate | | | |
| Example 3-13 | 0.5 | 0.7 | 0.7 | 1.9 | 3 | 0.6 | 95.1 | Lithium | 35 | 16% | 390 |
| | | | | | | | | cobaltate | | | |
| Example 3-14 | 0.3 | 0.5 | 0.5 | 1.3 | 2.5 | 0.5 | 96.2 | Lithium | 50 | 14% | 410 |
| | | | | | | | | iron | | | |
| | | | | | | | | phosphate | | | |

The mass percentage C₂ of the binder usually affects the internal resistance and high-temperature storage performance of secondary batteries. From Example 1-1, Examples 3-1 to 3-6, it can be seen that in secondary batteries using a mass percentage C₂ of the binder within the range of the present application, positive electrode plates exhibited a relatively high cohesion and a relatively low resistance, and the secondary batteries had a relatively low thickness swelling rate after 7 hours of storage at 80° C., indicating that the secondary batteries exhibited good high-temperature storage performance without affecting internal resistance.

When second carbon nanotubes were further introduced into the positive electrode active material layer, the mass percentage W₃ of the second carbon nanotubes usually affects the internal resistance and high-temperature storage performance of secondary batteries. From Example 1-1, Examples 3-7 to 3-13, it can be seen that in secondary batteries using a mass percentage W₃ of the second carbon nanotubes within the range of the present application, positive electrode plates exhibited a relatively high cohesion and a relatively low resistance, and the secondary batteries had a relatively low thickness swelling rate after 7 hours of storage at 80° C., indicating that the secondary batteries exhibited good high-temperature storage performance without affecting internal resistance.

The ratio C₁/C₂ of the mass percentage C₁ of the positive electrode conductive agent and the mass percentage C₂ of the binder usually affects the internal resistance and high-temperature storage performance of secondary batteries. From Example 1-1, Examples 3-1 to 3-6, it can be seen that in secondary batteries using a ratio C₁/C₂ of the mass percentage C₁ of the positive electrode conductive agent and the mass percentage C₂ of the binder within the range of the present application, positive electrode plates exhibited a relatively high cohesion and a relatively low resistance, and the secondary batteries had a relatively low thickness swelling rate after 7 hours of storage at 80° C., indicating that the secondary batteries exhibited good high-temperature storage performance without affecting internal resistance.

The mass percentage and type of positive electrode active material usually affect the internal resistance and high-temperature storage performance of secondary batteries. From Example 1-1, Examples 3-1 to 3-14, it can be seen that in secondary batteries using a mass percentage and type of positive electrode active material within the range of the present application, positive electrode plates exhibited a relatively high cohesion and a relatively low resistance, and the secondary batteries had a relatively low thickness swelling rate after 7 hours of storage at 80° C., indicating that the secondary batteries exhibited good high-temperature storage performance without affecting internal resistance. The positive electrode active material content in Example 3-13 was too low, leading to a decrease in the energy density of the secondary battery.

TABLE 4

| | | Bulk density | | | |
|---|---|---|---|---|---|
| | | of positive | | | |
| | | electrode | | | |
| | | active | | Thickness | |
| | | material layer | Cohesion | swelling | Resistance |
| | Type of binder | (g/cm³) | (N/m) | rate | (mΩ) |
| Example | Polyvinylidene fluoride | 4 | 60 | 10% | 380 |
| 1-1 | (Mw = 80 W) | | | | |
| Example | Vinylidene fluoride- | 4 | 50 | 14% | 380 |
| 4-1 | hexafluoropropylene | | | | |
| | copolymer (Mw = 80 W) | | | | |
| Example | Styrene-butadiene | 4 | 45 | 15% | 380 |
| 4-2 | rubber (Mw = 100 W) | | | | |
| Example | Sodium polyacrylate | 4 | 55 | 12% | 380 |
| 4-3 | (Mw = 70 W) | | | | |
| Example | Polyvinylidene fluoride | 3.9 | 55 | 10% | 370 |
| 4-4 | (Mw = 80 W) | | | | |
| Example | Polyvinylidene fluoride | 4.15 | 60 | 12% | 360 |
| 4-5 | (Mw = 80 W) | | | | |
| Example | Polyvinylidene fluoride | 3.8 | 50 | 14% | 390 |
| 4-6 | (Mw = 80 W) | | | | |
| Example | Polyvinylidene fluoride | 4.25 | 50 | 16% | 400 |
| 4-7 | (Mw = 80 W) | | | | |

The type of binder usually affects the internal resistance and high-temperature storage performance of secondary batteries. From Example 1-1, Examples 4-1 to 4-3, it can be seen that in secondary batteries using a type of binder within the range of the present application, positive electrode plates exhibited a relatively high cohesion and a relatively low resistance, and the secondary batteries had a relatively low thickness swelling rate after 7 hours of storage at 80° C., indicating that the secondary batteries exhibited good high-temperature storage performance without affecting internal resistance.

The bulk density of the positive electrode active material layer usually affects the internal resistance and high-temperature storage performance of secondary batteries. From Example 1-1, Examples 4-4 to 4-7, it can be seen that in secondary batteries using the positive electrode active material layer with a bulk density within the range of the present application, positive electrode plates exhibited a relatively high cohesion and a relatively low resistance, and the secondary batteries had a relatively low thickness swelling rate after 7 hours of storage at 80° C., indicating that the secondary batteries exhibited good high-temperature storage performance without affecting internal resistance.

TABLE 5

| | Tube diameter | Length of | | | |
|---|---|---|---|---|---|
| | of second | second carbon | | Thickness | |
| | carbon | nanotubes | Cohesion | swelling | Resistance |
| | nanotubes (nm) | (μm) | (N/m) | rate | (mΩ) |
| Example 1-1 | \ | \ | 60 | 10% | 380 |
| Example 5-1 | 11 | 2 | 68 | 6% | 310 |
| Example 5-2 | 3 | 2 | 62 | 9% | 280 |
| Example 5-3 | 20 | 2 | 62 | 9% | 350 |
| Example 5-4 | 1 | 2 | 35 | 16% | 305 |
| Example 5-5 | 22 | 2 | 40 | 15% | 380 |
| Example 5-6 | 11 | 1 | 65 | 8% | 400 |
| Example 5-7 | 11 | 3 | 65 | 8% | 360 |
| Example 5-8 | 11 | 0.5 | 55 | 12% | 420 |
| Example 5-9 | 11 | 3.5 | 55 | 12% | 350 |

Note:
“\” in Table 5 indicates no corresponding parameter.

The tube diameter of the second carbon nanotubes usually affects the internal resistance and high-temperature storage performance of secondary batteries. From Example 1-1, Examples 5-1 to 5-5, it can be seen that in secondary batteries in which second carbon nanotubes were introduced and the tube diameter of the second carbon nanotubes was within the range of the present application, positive electrode plates exhibited a relatively high cohesion and a relatively low resistance, and the secondary batteries had a relatively low thickness swelling rate after 7 hours of storage at 80° C., indicating that the secondary batteries exhibited good high-temperature storage performance without affecting internal resistance.

The length of the second carbon nanotubes usually affects the internal resistance and high-temperature storage performance of secondary batteries. From Example 5-1, Examples 5-6 to 5-9, it can be seen that in secondary batteries using second carbon nanotubes with lengths within the range of the present application, positive electrode plates exhibited a relatively high cohesion and a relatively low resistance, and the secondary batteries had a relatively low thickness swelling rate after 7 hours of storage at 80° C., indicating that the secondary batteries exhibited good high-temperature storage performance without affecting internal resistance.

It should be noted that in this text, relational terms such as first and second are only used to distinguish one entity or operation from another entity or operation, and do not necessarily require or imply any such actual relationship or order between these entities or operations. Moreover, the terms “comprise,” “include,” or any other variation thereof are intended to cover non-exclusive inclusion, so that a process, method, article, or device that includes a series of elements not only includes those elements, but also includes other elements not explicitly listed, or also includes elements inherent to such a process, method, article, or device.

Each embodiment in this specification is described in a related manner, and the same or similar parts between the various embodiments can be referred to each other. The focus of each embodiment is to explain the differences from other embodiments.

The above are only preferred embodiments of the present application and are not intended to limit the present application. Any modifications, equivalent substitutions, improvements, or the like made within the spirit and principles of the present application shall be included within the scope of protection of the present application.

What is claimed is:

1. A positive electrode plate, comprising a positive current collector and a positive electrode active material layer disposed on at least one surface of the positive current collector, the positive electrode active material layer comprising a positive electrode conductive agent, the positive electrode conductive agent comprising carbon black particles and first carbon nanotubes having a clustered structure, the first carbon nanotubes being composed of multiple carbon nanotube units arranged in bundles; wherein
a particle size of the carbon black particles is R₁, wherein 3 nm≤R₁≤40 nm; and
a tube diameter of the first carbon nanotubes is 0.5 μm to 2 μm, and a diameter of each carbon nanotube unit is R₂, wherein 5 nm≤R₂≤25 nm.

2. The positive electrode plate according to claim 1, wherein the positive electrode plate satisfies at least one of the following characteristics:
(1) 8 nm≤R₁≤15 nm;
(2) a tube diameter of the first carbon nanotubes is 0.8 μm to 1.2 μm; and
(3) 8 nm≤R₂≤20 nm.

3. The positive electrode plate according to claim 1, wherein based on a mass of the positive electrode active material layer, a mass percentage of the carbon black particles is W₁, and a mass percentage of the first carbon nanotubes is W₂, 0.2%≤W₁≤1.0%, and 0.2%≤W₂≤0.8%.

4. The positive electrode plate according to claim 3, wherein 0.2≤(W₁/R₁)/(W₂/R₂)≤1.3.

5. The positive electrode plate according to claim 1, wherein R₁≤2R₂.

6. The positive electrode plate according to claim 1, wherein a length of the first carbon nanotubes is 5 μm to 10 μm.

7. The positive electrode plate according to claim 1, wherein a specific surface area of the carbon black particles is 500 m²/g to 1600 m²/g.

8. The positive electrode plate according to claim 1, wherein a specific surface area of the carbon black particles is 800 m²/g to 1400 m²/g.

9. The positive electrode plate according to claim 1, wherein the positive electrode conductive agent further comprises individually distributed second carbon nanotubes, a tube diameter of the second carbon nanotubes is 3 nm to 20 nm, and a length of the second carbon nanotubes is 1 μm to 3 μm.

10. The positive electrode plate according to claim 9, wherein based on the mass of the positive electrode active material layer, a mass percentage of the second carbon nanotubes is W₃, with 0%<W₃≤0.5%.

11. The positive electrode plate according to claim 1, wherein the positive electrode active material layer further comprises a binder;
based on the positive electrode active material layer, a mass percentage of the positive electrode conductive agent is C₁, and a mass percentage of the binder is C₂, 0.5≤C₁/C₂≤1.5 and 0.8%≤C₂≤3%.

12. The positive electrode plate according to claim 11, wherein the binder comprises at least one of polyvinylidene fluoride, vinylidene fluoride-hexafluoropropylene copolymer, polyacrylonitrile, polyacrylate, polyacrylic acid, polyacrylate salt, polyvinylpyrrolidone, polyamide, polyvinyl ether, polymethyl methacrylate, polytetrafluoroethylene, polyhexafluoropropylene, styrene-butadiene rubber, polypropylene, polyethylene, polytetrafluoroethylene, polyetherimide, hydrogenated nitrile rubber, or carboxymethyl cellulose salt.

13. The positive electrode plate according to claim 1, wherein the positive electrode active material layer further comprises a positive electrode active material; the positive electrode active material comprising at least one of lithium cobaltate, lithium manganate, lithium nickelate, lithium nickel cobalt manganate, lithium nickel cobalt aluminate, lithium iron phosphate, lithium manganese iron phosphate, lithium vanadium phosphate, lithium-rich manganese-based material, or lithium titanate; and
based on the mass of the positive electrode active material layer, a mass percentage of the positive electrode active material is 95.4% to 98.5%.

14. The positive electrode plate according to claim 1, wherein a bulk density of the positive electrode active material layer is 3.9 g/cm³ to 4.15 g/cm³.

15. The positive electrode plate according to claim 1, wherein a cohesion of the positive electrode plate is 30 N/m to 85 N/m.

16. A secondary battery, wherein the secondary battery comprises a positive electrode plate, wherein the positive electrode plate comprises a positive current collector and a positive electrode active material layer disposed on at least one surface of the positive current collector, the positive electrode active material layer comprising a positive electrode conductive agent, the positive electrode conductive agent comprising carbon black particles and first carbon nanotubes having a clustered structure, the first carbon nanotubes being composed of multiple carbon nanotube units arranged in bundles; wherein
a particle size of the carbon black particles is R₁, wherein 3 nm≤R₁≤40 nm; and
a tube diameter of the first carbon nanotubes is 0.5 μm to 2 μm, and a diameter of each carbon nanotube unit is R₂, wherein 5 nm≤R₂≤25 nm.

17. The secondary battery according to claim 16, wherein the positive electrode plate satisfies at least one of the following characteristics:
(1) 8 nm≤R₁≤15 nm;
(2) a tube diameter of the first carbon nanotubes is 0.8 μm to 1.2 μm; and
(3) 8 nm≤R₂≤20 nm.

18. The secondary battery according to claim 16, wherein based on a mass of the positive electrode active material layer, a mass percentage of the carbon black particles is W₁, and a mass percentage of the first carbon nanotubes is W₂, 0.2%≤W₁≤1.0% and 0.2%≤W₂≤0.8%.

19. The secondary battery according to claim 16, wherein 0.2≤(W₁/R₁)/(W₂/R₂)≤1.3.

20. An electronic apparatus, wherein the electronic apparatus comprises the secondary battery according to claim 16.
